(19) United States
(12) Patent Application Publication
(10) Pub. No.: US 2008/0195821 A1
(43) Pub. Date: Aug. 14, 2008

(54) METHOD AND SYSTEM OF FAST CLEARING OF MEMORY USING A BUILT-IN SELF-TEST CIRCUIT

(76) Inventors: Lewis Adams, Carmel, CA (US); Alan Herring, San Jose, CA (US)

Correspondence Address: MURABITO, HAO & BARNES, LLP, TWO NORTH MARKET STREET, THIRD FLOOR, SAN JOSE, CA, 95113, US

(21) Appl. No.: 12/029,338

(22) Filed: Feb. 11, 2008

Related U.S. Application Data
(60) Provisional application No. 60/901,146, filed on Feb. 13, 2007.

(51) Int. Cl. G06F 12/02

(52) U.S. Cl. 711/154; 711/E12.002

(57) ABSTRACT

Systems, devices and methods for clearing memory using a built-in self-test circuit are disclosed. In one embodiment, a device for clearing memory using a built-in self-test circuit comprises a clear memory module added to a memory built-in self-test (MBIST) controller generating a signal for clearing one or more memory modules and one or more wrapper circuits with each wrapper circuit comprising an address generator module forwarding a range of addresses associated with the clearing the memory modules, a write data generator module forwarding a pattern of logical zeroes to the range of addresses and a finite state machine controlling writing the pattern to the range of addresses based on the signal for the clearing the memory modules.

### CLAIM OF PRIORITY

This application claims priority from a U.S. patent application 60/901,146 titled “METHOD AND SYSTEM OF FAST CLEARING OF MEMORY USING BIST CIRCUITS” filed on Feb. 13, 2007.

### FIELD OF TECHNOLOGY

This disclosure relates generally to technical fields of testing devices and, in one embodiment, to method and system of fast clearing of memory using a built-in self-test circuit.

### BACKGROUND

A memory or random access memory (RAM) is a series of microchips that can be inserted into or removed from sockets of a motherboard. The RAM is a temporary or volatile storage of data, so the data are removed once power is lost for the RAM. A typical computer would have 512 MB to 2 GB of the RAM installed, and the size of the RAM in the computer is continually increasing.

Since the computer can access data from the RAM much faster than it could from a harddrive, the RAM is often paired with the harddrive. Thus, when an application is launched in the computer, the harddrive constantly load data into the RAM so that the contents in the RAM can be fast accessed by the computer. The data that is loaded to the RAM stays in the RAM, until the data are no longer needed or the computer is restarted.

When power is first applied to a device containing embedded RAM, the state of the RAM is unknown. Most computer programs assume that the values in RAM are zero, so it is usually necessary to clear the RAM before using it. Modern computer programs also frequently allocate and de-allocate memory dynamically. Each time a particular block of memory is allocated, it must be cleared.

Before using the RAM for temporary storage for another application, the RAM needs to be cleared. The memory clear operation may be performed by writing zeroes to the memory. The memory clear operation is usually performed by executing a software program, but it often takes long time to clear the memory. The problem becomes more evident as the size of RAM in the computer is rapidly increasing as the price of the RAM falls. Another option is implementing a hardware module to carry out the clear operation, but it is costly and adds to the real estate of the computer.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

An embodiment described in the detailed description is directed to a system for clearing memory using a built-in self-test circuit comprising one or more memory modules, a memory built-in self-test (MBIST) controller forwarding a signal for clearing the memory modules, and one or more wrapper circuits, where each wrapper circuit is coupled to the memory built-in self-test controller and to a respective one of the memory modules.

Another embodiment described in the detailed description is directed to a device for clearing memory using a built-in self-test circuit comprising a memory built-in self-test (MBIST) controller generating a signal for clearing one or more memory modules and one or more wrapper circuits with each wrapper circuit comprising an address generator module forwarding a range of addresses associated with the clearing the memory modules, a write data generator module forwarding a pattern of logical zeroes to the range of addresses and a finite state machine controlling writing the pattern to the range of addresses based on the signal for the clearing the memory modules.

Yet another embodiment described in the detailed description is directed to a method for clearing memory using a built-in self-test circuit comprising detecting an input signal for clearing one or more memory modules, determining respective ranges of addresses for the clearing the memory modules based on the input signal and writing logical zeroes to contents of the ranges of addresses.

As illustrated in the detailed description, other embodiments pertain to systems, devices and/or methods that fast clear memories using a built-in self-test circuit by using one or more wrapper circuits associated with the memories if a signal for clear operation of the memories is detected. It is appreciated that the memory built-in self-test circuit is already present in a system on chip containing embedded RAM, and this invention adds control circuitry to the pre-existing memory built-in self-test circuit in order to allow it to perform the memory clear function. It is also appreciated that the exact structure of the pre-existing memory built-in self-test circuit is not important as most memory built-in self-test structures can be extended in this way.

### BRIEF DESCRIPTION OF THE DRAWINGS

Example embodiments are illustrated by way of example and not limitation in the figures of the accompanying drawings, in which like references indicate similar elements and in which:

FIG. 1 is an exemplary system for clearing memory using a built-in self-test circuit, according to one embodiment.

FIG. 2 is an exemplary flow chart for operating the system illustrated in FIG. 1, according to one embodiment.

FIG. 3 is an exemplary block diagram of the system illustrated in FIG. 1, according to one embodiment.

FIG. 4 is an exemplary process flow chart for clearing memory using a built-in self-test circuit, according to one embodiment.

Other features of the present embodiments will be apparent from the accompanying drawings and from the detailed description that follows.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Briefly stated, embodiments reduce the time and/or power to clear memories in a device or system. This is achieved through detecting a signal for clearing memory and performing the task using a built-in self-test circuit.

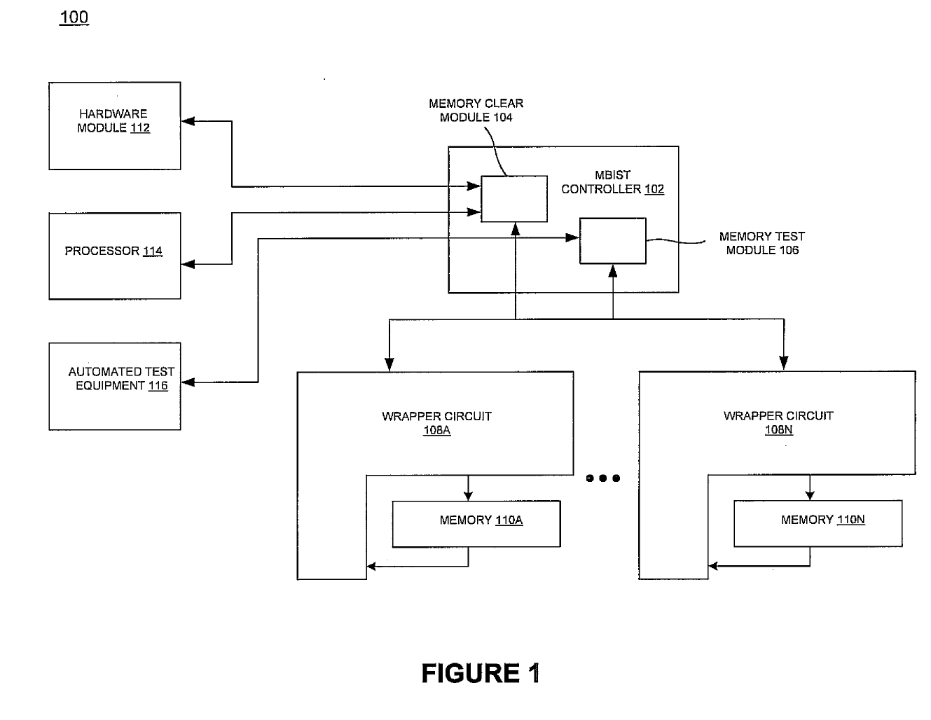

FIG. 1 is an exemplary system for clearing memory using a built-in self-test circuit, according to one embodiment. A system for clearing memory using a built-in self-test circuit 100 includes one or more memory modules (e.g., 110A, 110N, etc.), a memory built-in self-test (MBIST) controller 102 forwarding a signal for clearing the memory modules, and one or more wrapper circuits for performing the clearing the memory modules based on the signal, where each of the wrapper circuits (e.g., 108A, 108N, etc.) is coupled to the memory built-in self-test controller 102 and to a respective one of the memory modules, and where the built-in self-test circuit comprises the memory built-in self-test controller 102 and the wrapper circuits. The memory modules may be a SRAM, a DRAM, a Flash ROM, and/or other memory that may be erased and/or rewritten.

The memory built-in self-test controller 102 comprises a memory clear module 104 which generates the signal for clearing the memory modules if an input signal is forwarded by a hardware module 112 (e.g., a power-on reset circuit) or a processor 114 (e.g., a microcontroller, a central processing unit, etc.) coupled to the memory built-in self-test controller 102.

In one exemplary embodiment, the input signal from the hardware module 112 triggers the clearing the memory modules in entirety. For example, the input signal may instruct the memory built-in self-test controller 102 to clear all the contents of the memory modules. Since the operation is performed in parallel for each one of the memory modules using the wrapper circuits associated with their respective memory modules, multiples of memory modules can be cleared within the time it takes to clear single memory module.

In one exemplary embodiment, the input signal from the processor 114 triggers the clearing the memory modules in part. In such a case, the input signal includes one or more addresses in the memory modules as well as a set of instructions for clearing contents in the addresses. For example, the input signal forwarded by the processor 114 may include a range of addresses in a particular memory module among the memory modules. Clearing of the memory modules can be also automatically triggered by a program error associated with any one of the memory modules.

The memory built-in self-test controller 102 also comprises a memory test module 106 which generates a signal for testing the memory modules if an input signal is forwarded by an automated test equipment (ATE) 116 coupled to the memory built-in self-test controller 102.

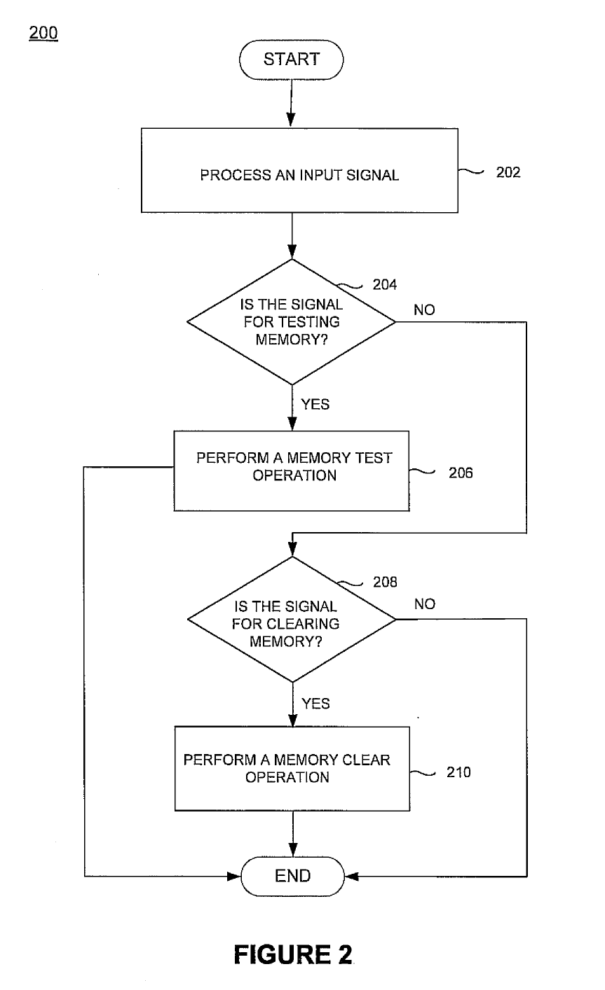

FIG. 2 is an exemplary flow chart for operating the system illustrated in FIG. 1, according to one embodiment. In operation 202, an input signal is processed in a memory built-in self-test controller. If the signal is for testing memory in operation 204, a memory test operation is performed in operation 206 using the built-in self-test circuit as illustrated in FIG. 1. If the signal is for clearing memory in operation 208, a memory clear operation is performed in operation 210 using a built-in self-test circuit. In one exemplary embodiment, the built-in self-test circuit includes a memory built-in self-test controller and one or more wrapper circuits associated with their respective memory modules.

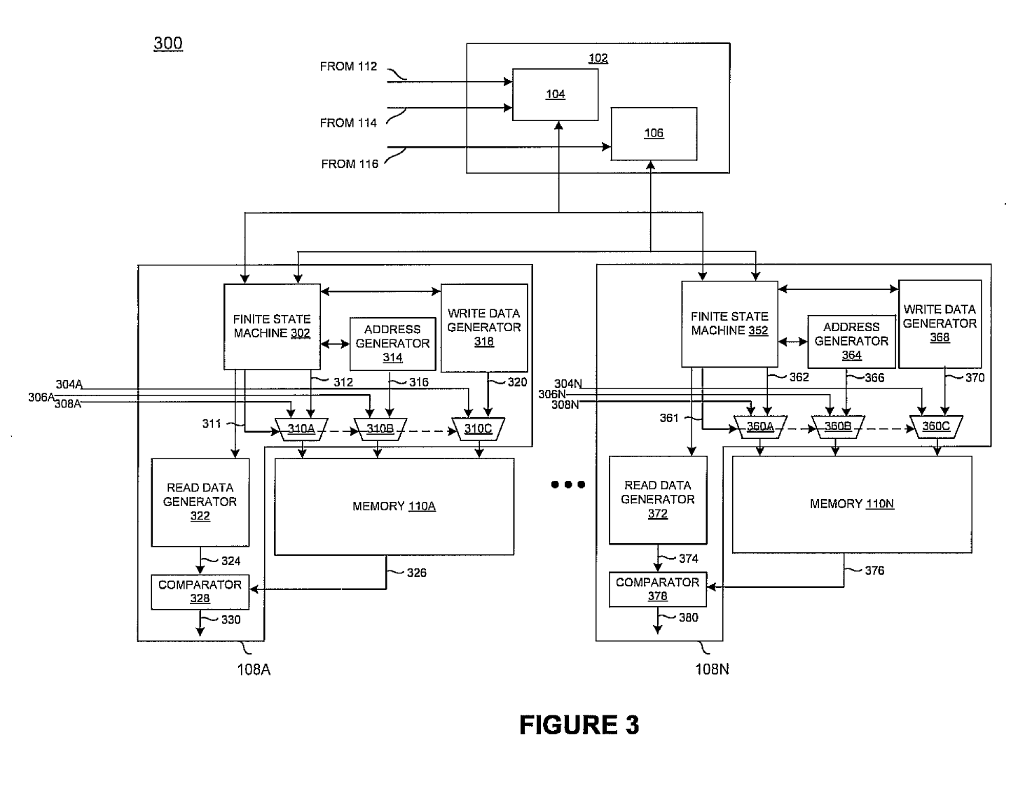

FIG. 3 is an exemplary block diagram of the system illustrated in FIG. 1, according to one embodiment. In FIG. 3, a built-in self-test (MBIST) controller 102 is coupled to one or more wrapper circuits (e.g., 108A, 108N, etc.). The MBIST Controller 102 processes one or more instructions by the hardware module 112, the processor 114 and/or the automated test equipment (ATE) 116.

The hardware module 112 or the processor 114 may forward an input signal to the memory built-in self-test controller 102. This signal is processed by the memory clear module 104 to initiate a memory clear operation. The automated test equipment 116 may forward an input signal to the memory built-in self-test controller 102. This signal is processed by the memory test module 106 to initiate a memory test operation.

Each of the wrapper circuits may be a circuit around a memory (e.g., 110A, 110N, etc.). The memory may be a volatile memory (e.g., volatile RAM) or a non volatile memory (e.g., non-volatile RAM, flash memory, etc.). The wrapper circuit (e.g., 108A, 108N, etc.) includes a finite state machine, an address generator, a write data generator, a control bus multiplexer, an address bus multiplexer, a data bus multiplexer, a read data generator and a comparator.

The finite state machine (e.g., 302, 352, etc.) controls an execution for the memory test operation or memory clear operation. The finite state machine also forwards a configuration signal 361 to cause the control bus multiplexer, the address bus multiplexer and the data bus multiplexer to forward signals from the finite state machine, the address generator and write data generator, respectively. The address generator (e.g., 314, 364, etc.) is a circuit that randomly and/or deterministically generate addresses used to access the memory. The write data generator (e.g., 318, 368, etc.) is a circuit that randomly and/or deterministically generate data or a pattern of data used to write to the memory.

The control bus multiplexer (e.g., 310A, 360A, etc.) multiplexes a control bus (e.g., 308A, 308N, etc.) and a signal (e.g., 312, 362, etc.) coming from the finite state machine. When performing a memory self-test or clear operation, the finite state machine generates the signal to enable writing (e.g., encoding) to the memory and/or reading (e.g., decoding) from the memory. In regular operation mode, the read or write enable is forwarded by the control bus.

The address bus multiplexer (e.g., 310B, 360B, etc.) multiplexes an address bus (e.g., 306A, 306N, etc.) and a signal (e.g., 316, 366, etc.) coming from the address generator. When performing the memory self-test or clear operation, one or more addresses are forwarded by the address generator. In regular operation mode, one or more addresses are forwarded via the address bus.

The data multiplexer (e.g., 310C, 360C, etc.) multiplexes data from a data bus (e.g., 304A, 304N, etc.) and a signal (e.g., 320, 370, etc.) coming from the write data generator. When performing the memory self-test or clear operation, the data or a pattern of the data used in the memory self-test or clear operation is forwarded by the write data generator. In regular operation mode, the data is forwarded via the data bus.

The read data generator (e.g., 322, 372, etc.) controlled by the finite state machine is a circuit that serves to account for the patterns written to the memory. The patterns are used to compare with the content of the memory during the self-test operation. The comparator module (e.g., 328, 378, etc.) is a circuit that checks the data forwarded by the read data generator against the content in addresses of the memory allotted for the self-test operation. It is appreciated that the write data generator and the read data generator can be realized using single module.

During the normal operation mode (e.g., which is neither the memory clear operation nor the memory test operation), data (e.g., 304A, 304N, etc.) may be written to the memory (e.g., 110A, 110N, etc.). A control signal (e.g., 306A, 306N, etc.) may be used to enable the read or write operation of the memory. An address bus (e.g., 308A, 308N, etc.) may be used to specify an address of the memory that may be written and/or read.

In an alternative exemplary embodiment, that a device for clearing memory is performed using a built-in self-test circuit. The built-in self-test circuit includes the memory built-in self-test controller 102 and one or more wrapper circuits (e.g., 108A, 108N, etc.) coupled to their respective memory modules. The built-in self-test controller 102 generates a signal for clearing the memory modules in part or in entirety using the memory module 104 based on an input signal from the hardware module 112 (e.g., a power-on reset circuit) or the processor 114. In addition, the built-in self-test controller 102 generates a signal for testing the memory modules using the memory test module 106 based on an input signal from the automated test equipment 116.

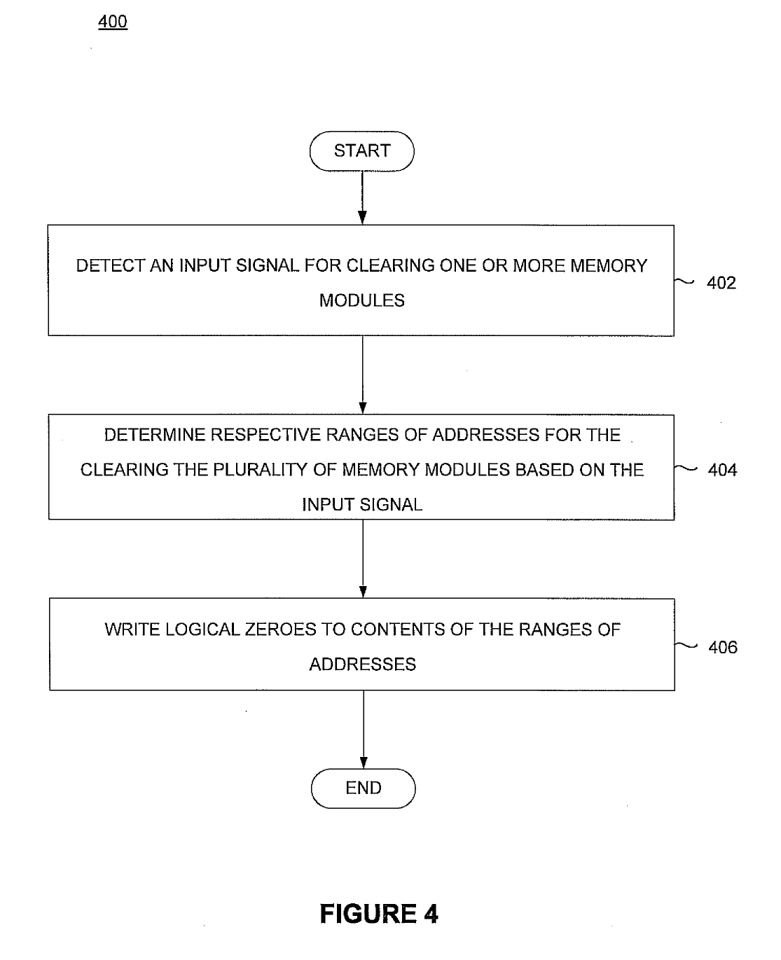

FIG. 4 is process flow chart for clearing memory using a built-in self-test circuit, according to one embodiment. In operation 402, an input signal for clearing one or more memory modules is detected (e.g., using the memory built-in self-test controller 102). In operation 404, respective ranges of addresses for the clearing the memory modules are determined based on the input signal. For example, if a power-on reset circuit forwards the input signal, every writable address in the memory modules is cleared. On the other hand, if a processor forwards the input signal to clear a portion or portions of the memory modules, the instructions for the memory clear operation may be accompanied with a range or ranges of addresses for the portion or portions, respectively. In operation 406, logical zeroes are written to contents of the addresses. Other embodiments will be apparent from the accompanying drawings and from the detailed description that follows. Moreover, the process described in operations 402 and 406 may be coded to a machine readable medium, and may be performed when the machine readable medium is executed by a machine (e.g., a computer, etc.).

In summary, embodiments described herein pertain to systems, devices and methods that reduce the time and/or power for clearing memory using a built-in self-test circuit. Through adding a novel feature of clearing memory to an already existing built-in self-test circuit, embodiments provide more cost effective and fast ways of performing the clear operation of memory.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for clearing memory using a built-in self-test circuit, comprising:
a plurality of memory modules;
a memory built-in self-test (MBIST) controller forwarding a signal for clearing the plurality of memory modules; and
a plurality of wrapper circuits for performing the clearing the plurality of memory modules based on the signal,
wherein each of the plurality of wrapper circuits is coupled to the memory built-in self-test controller and to a respective one of the plurality of memory modules.

2. The system of claim 1, wherein the memory built-in self-test controller comprises a memory clear module generating the signal for the clearing the plurality of memory modules based on an input signal from a hardware module or a processor.

3. The system of claim 2, wherein the input signal from the hardware module triggers the clearing the plurality of memory modules in entirety.

4. The system of claim 3, wherein the hardware module comprises a power-on reset circuit.

5. The system of claim 2, wherein the input signal from the processor triggers the clearing the plurality of memory modules in part.

6. The system of claim 5, wherein the input signal comprises at least one address in the plurality of memory modules associated with performing the clearing the plurality of memory modules in part.

7. The system of claim 1, wherein the clearing the plurality of memory modules is automatically triggered by a program error associated with the plurality of memory modules.

8. The system of claim 1, wherein the wrapper circuit comprises:
an address generator module forwarding at least one address for the clearing the plurality of memory modules;
a write data generator module forwarding at least one data pattern for the clearing the plurality of memory modules; and
a finite state machine controlling writing of the at least one data pattern to the at least one address based on the signal for the clearing the plurality of memory modules.

9. The system of claim 8, wherein the at least one data pattern comprises a pattern with at least one logical zero.

10. The system of claim 1, wherein the memory built-in self-test controller comprises a memory test module generating a signal for testing the plurality of memory modules if an input signal is forwarded by an automated test equipment (ATE).

11. The system of claim 10, wherein the wrapper circuit comprises:
an address generator module forwarding at least one address for the testing the plurality of memory modules;
a write data generator module forwarding at least one data pattern for the testing the plurality of memory modules;
a finite state machine controlling writing of the at least one data pattern to the at least one address based on the signal for the testing the plurality of memory modules; and
a comparator module comparing contents of the at least one address with the at least one data pattern.

12. A device for clearing memory using a built-in self-test circuit, comprising:
a memory built-in self-test (MBIST) controller generating a signal for clearing at least one memory module; and
a plurality of wrapper circuits performing the clearing the at least one memory module,
wherein each of the plurality of wrapper circuits comprising:
an address generator module forwarding a range of addresses associated with the clearing the at least one memory module;
a write data generator module forwarding a pattern of logical zeroes to the range of addresses; and
a finite state machine controlling writing of the pattern to the range of addresses based on the signal for the clearing the at least one memory module.

13. The device of claim 12, wherein the memory built-in self-test controller comprises a memory clear module generating the signal for the clearing the at least one memory based on an input signal.

14. The device of claim 13, wherein the input signal is forwarded by a power-on reset circuit module coupled to the memory built-in self-test controller.

15. The device of claim 13, wherein the input signal is forwarded by a processor coupled to the memory built-in self-test controller.

16. The device of claim 12, wherein the memory built-in self-test controller comprises a memory test module generating a signal for testing the at least one of memory module if an input signal is forwarded by an automated test equipment (ATE).

17. A method for clearing memory using a built-in self-test circuit, comprising:
detecting an input signal for clearing a plurality of memory modules;
determining respective ranges of addresses for the clearing the plurality of memory modules based on the input signal; and
writing logical zeroes to contents of the ranges of addresses.

18. The method of claim 17, wherein the input signal for the clearing the plurality of memory modules is forwarded by a hardware module.

19. The method of claim 18, wherein the input signal from the hardware module triggers the clearing the plurality of memory modules in entirety.

20. The method of claim 17, wherein the input signal from a processor coupled to the built-in self-test circuit triggers the clearing the plurality of memory modules in part.
